(19) United States
(12) Patent Application Publication
(10) Pub. No.: US 2026/0342716 A1
(43) Pub. Date: Oct. 29, 2026

(54) ACCELERATED MULTIPLANE ROUTING

(71) Applicant: Mellanox Technologies, Ltd., Yokneam (IL)

(72) Inventor: Chen Rozenbaum, Beer Yakov (IL)

(21) Appl. No.: 19/191,537

(22) Filed: Apr. 28, 2025

(51) Int. Cl. H04L 45/24; H04L 45/28; H04L 45/586; H04L 45/745

(52) U.S. Cl. CPC H04L 45/24; H04L 45/28; H04L 45/586; H04L 45/745

(57) ABSTRACT

Technologies for providing accelerated routing service with multiplane support are described. One method exchanges, by an accelerated routing service executed by a host device, control traffic with other accelerated routing services executed by other host devices. The method configures, using the control traffic, a virtual bridge with a first set of multiplane routing rules that specify a first set of available data planes for each of the host devices. The method configures, using the virtual bridge, registers associated with a plurality of network adapters. The method receives at the virtual bridge a first packet directed to a first destination host device, and routes, using the virtual bridge according to the first set of multiplane routing rules, the first packet to one of the first set of available data planes to the first destination host device.

### TECHNICAL FIELD

At least one embodiment pertains to processing resources used to perform and facilitate operations for providing accelerated routing service with multiplane support. For example, at least one embodiment pertains to processors or computing systems used to provide and enable an acceleration hardware engine to provide accelerated routing of network traffic data in multiple accelerated data planes, according to various novel techniques described herein.

### BACKGROUND

In traditional network architectures, various security and performance functions were managed by specialized hardware devices known as middleboxes, each serving distinct roles. Firewalls, as standalone physical appliances, served as the primary defense mechanism at the network's edge, scrutinizing incoming and outgoing traffic based on set rules to block or allow data transmission, thereby safeguarding the internal network from external threats. Load balancers operated as separate hardware units, intelligently distributing incoming network and application traffic across multiple servers to prevent overload and ensure efficient resource utilization, thereby enhancing application availability and performance. Intrusion Detection Systems (IDS), positioned strategically within the network, were dedicated to monitoring and analyzing network traffic for signs of anomalies, attacks, or security policy violations, acting as a security component in identifying potential security breaches.

Additionally, networks utilize other middlebox functions like Data Loss Prevention (DLP) systems to monitor and prevent unauthorized data exfiltration, virtual private network (VPN) Gateways to establish secure and encrypted connections across networks, and Wide Area Network (WAN) Optimization appliances designed to improve data transfer efficiency across wide area networks. These middleboxes were essential but came with challenges: they required significant capital investment, occupied valuable space in data centers, and demanded specialized personnel for operation and maintenance. Scaling these network functions often meant acquiring and integrating more physical devices, which added to the complexity and cost of the network infrastructure.

### BRIEF DESCRIPTION OF DRAWINGS

Various embodiments in accordance with the present disclosure will be described with reference to the drawings, in which:

FIG. 1 is a block diagram of a computing system with a multiplane routing logic for providing a virtual bridge and an accelerated routing service with multiplane support according to at least one embodiment.

FIG. 2 is a block diagram of a software stack of a host device with a virtual bridge and an accelerated routing service with multiplane support according to at least one embodiment.

FIG. 3A is a block diagram of a 2-tier spine-leaf topology according to at least one embodiment.

FIG. 3B is a block diagram of a 3-tier spine-leaf topology according to at least one embodiment.

FIG. 4A is a block diagram of a multiplane topology where multiple NICs where multiple NICs each support multiple planes according to at least one embodiment.

FIG. 4B is a block diagram of the multiplane topology of FIG. 4A where one of the planes has a plane failure according to at least one embodiment.

FIG. 5 is a flow diagram of an example method of providing accelerated multiplane routing to destination host devices according to at least one embodiment.

FIG. 6 illustrates an example computer system, including an accelerated routing service with multiplane support, in accordance with at least some embodiments.

FIG. 7 is a block diagram of a computing system having two processing devices coupled to each other and multiple networks according to at least one embodiment.

FIG. 8 is a block diagram of a computing system having a central processing unit (CPU) and a graphics processing unit (GPU) in a single integrated circuit according to at least one embodiment.

FIG. 9 is a block diagram of a computing system having tensor core graphics processing units (GPUs) according to at least one embodiment.

### DETAILED DESCRIPTION

Technologies for providing accelerated routing service with multiplane support are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

As described above, in traditional network architectures, various security and performance functions were managed by specialized hardware devices known as middleboxes (e.g., firewalls, load balancers, IDSs, etc.). Traditional networks were designed with the assumption that all resources would be housed within an on-premises data center, and often characterized by a centralized model.

Modern networks are increasingly cloud-centric, designed to support cloud services and applications. This includes the use of public, private, and hybrid cloud infrastructures, requiring networks to be more flexible and scalable. Unlike traditional network architectures that rely heavily on physical hardware (i.e., each network function requires its own dedicated device), current network architectures leverage virtualization technologies, such as software-defined networking (SDN) and network function virtualization (NFV). These allow network resources to be abstracted from hardware, providing greater flexibility, easier management, and reduced costs. Modern networks increasingly use automation and orchestration tools to manage network resources efficiently, reduce operational overhead, and enable faster deployment of network services. Modern networks are designed for scalability and high performance, utilizing technologies like edge computing to process data closer to the source and reduce latency. Current network architectures are more flexible, scalable, and efficient than traditional ones, designed to support the dynamic and distributed nature of modern computing resources and work practices. They integrate advanced technologies like cloud services, virtualization, and automation to meet the demands of today's digital environment.

Multiplane networking is a technique used in large-scale data centers to increase port radix, improve scalability, and reduce the number of spine-leaf levels in the network topology. A multiplane network includes multiple independent planes (groups of switches) that provide parallel paths for traffic between endpoints. Instead of having one large fabric, the network is divided into multiple smaller fabrics (planes), each operating independently but interconnecting at certain points. This approach increases the port radix of the fabric by distributing traffic across several independent paths, allowing more connections while keeping switch port count manageable. It also reduces the number of spine-leaf levels required in traditional Clos topologies, as multiplane networking allows traffic to be distributed across parallel planes, minimizing the need for additional layers. A Clos topology is a multistage switching network, often used in data centers, that allows any input to reach any output without blocking, even when the network is busy. It was first proposed by Charles Clos in 1952 and is parameterized by three integers: n (number of inputs), m (number of middle-stage switches), and r (number of outputs). Furthermore, multiplane networking improves fault tolerance and redundancy; if one plane fails, other planes continue forwarding traffic, ensuring higher reliability. Traffic can be load-balanced efficiently across multiple planes using Equal-Cost Multipath (ECMP), which optimizes load balancing. Additionally, this technique can decrease latency, as the spine-leaf topology will have fewer levels, resulting in fewer hops for each packet traversing the network and thus lowering end-to-end latency.

Some key differences between multiplane and non-multiplane fabrics are set forth below. A single fabric without multiplane can be a traditional Clos fabric with leaf switches connecting to servers, and spine switches providing interconnectivity between leaf switches. If more ports are needed, another layer of spine switches must be added, increasing network depth (latency).

Using multiplane (multiple fabrics), the entire network is split into separate fabrics (planes). Each plane contains its own set of spine and leaf switches. The leaf switches can be dual-homed or multi-homed across multiple planes, ensuring redundancy. Traffic between any two devices can traverse different planes, increasing total bandwidth and reducing hop count.

However, current deployments of host devices being coupled to leaf switches do not support multiplane because conventional NICs and DPUs do not support multiplane.

Aspects and embodiments of the present disclosure can provide a virtual bridge and an accelerated routing service with multiplane support. An accelerated routing service is a service routing protocol that includes data path protocols (i.e., IP, TCP/UDP) and control protocols (i.e., BGP) to configure multiplane decisions. Aspects and embodiments of the present disclosure can provide more available ports without increasing network depth, have less latency (fewer switch hops), provide more redundancy (failure in one plane does not affect others). The Key Benefits described in Table 1 below:

| Feature | Without Multiplane | With Multiplane |
|---|---|---|
| Port Scalability | Limited by switch radix | Scales using multiple |
| | | planes |
| Network Depth | More spine-leaf layers | Fewer layers (flatter |
| (Hop Count) | needed | topology) |
| Fault Tolerance | Single failure affects | Failover between planes |
| | traffic | |
| ECMP Load | Limited to single plane | Spread across multiple |
| Balancing | | planes |

### Data Processing Units (DPUS)

Aspects and embodiments of the present disclosure can provide acceleration of the multiplane routing at the underlying hardware, such as at the NICs or DPUs. In particular, when DPUs are used, the multiplane routing rules can be controlled by the accelerated routing service and accelerated by the DPU.

In modern network architectures, a DPU can be used to provide a set of software-defined networking, storage, security, and management services at a data-center scale with the ability to offload, accelerate, and isolate data center infrastructure. The DPU can offload processing tasks that a server's central processing unit (CPU) normally handles, such as any combination of encryption/decryption, firewall, transport control protocol/Internet Protocol (TCP/IP), and HyperText Transport Protocol (HTTP) processing, networking operations. A DPU can be an integrated circuit or a System on a Chip (SoC) that is considered a data center infrastructure on a chip. The CPU can include DPU hardware and DPU software (e.g., software framework with acceleration libraries). The DPU hardware can include a CPU (e.g., a single-core or multi-core CPU), one or more hardware accelerators, memory, one or more physical host interfaces that operatively couple to one or more host devices (e.g., a CPU of a host device), and one or more physical network interfaces that operatively couple to a network (e.g., a public network (e.g., the Internet), a private network (e.g., a local area network (LAN) or wide area network (WAN)), a wired network (e.g., Ethernet network), a wireless network (e.g., a 802.11 network or a Wi-Fi network), a cellular network (e.g., a Long Term Evolution (LTE) network), routers, hubs, switches, server computers, network adapters, NVLink switches, and/or a combination thereof). The DPU can handle network data path processing of network traffic data, whereas a host device can control path initialization and exception processing. The acceleration hardware engine (e.g., DPU hardware) can be used to offload and filter network traffic based on predefined filters using the hardware capabilities of the acceleration hardware engine. The software framework and acceleration libraries can include one or more hardware-accelerated services, including a hardware-accelerated service (e.g., NVIDIA DOCA), hardware-accelerated virtualization services, hardware-accelerated networking services, hardware-accelerated storage services, hardware-accelerated artificial intelligence/machine learning (AI/ML) services, hardware-accelerated service, and hardware-accelerated management services.

A DPU can provide accelerated networking services to one or more host devices. The DPU network services can be used for accelerating Layer 2 (L2) protocols, Layer 3 (L3) protocols, tunneling protocols, or the like, on the DPU hardware. The DPU can use a virtual bridge (e.g., Open vSwitch (OVS) bridge) controlled by a service, providing all accelerated networking capabilities. The service can support different protocols and different network capabilities, such as Access Control Lists (ACLs), an Equal-Cost Multi-Path (ECMP), tunneling, Connection Tracking (CT), Quality of Service (QoS) rule, Spanning Tree Protocol (STP), virtual local area network (VLAN) mapping, network address translations (NATs), software-defined networking (SDN), multi-protocol label switching (MPLS), etc.

### OVS and OVS Bridges

Aspects and embodiments of the present disclosure can provide a virtual bridge, such as OVS bridge. Open vSwitch (OVS) is an open-source, multi-layer virtual switch that is used to manage network traffic in virtualized environments, particularly in data centers and cloud computing platforms. OVS provides network connectivity between virtual machines (VMs), containers, and physical devices. OVS is widely used in virtualization and cloud technologies and is a typical component of many software-defined networking (SDN) and network virtualization solutions.

A virtual switch, often found in virtualized computing environments, is a software application that allows virtual machines (VMs) on a single physical host to communicate with each other and with the external network. The virtual switch can provide network connectivity between VMs, containers, and physical devices. The virtual switch can emulate the functionality of a physical network switch but operate at a software level within a hypervisor or a host operating system. The virtual switch can manage network traffic, directing data packets between VMs on the same host or between VMs and the physical network using ports. These ports can be configured for various policies like security settings, Quality of Service (QoS) rules, etc. The virtual switch can segment network traffic to provide isolation between different virtual networks. The virtual switch can provide an interface between the virtualized environment and the physical network, allowing VMs to communicate outside their host. The virtual switch can support standard networking protocols and features, such as virtual local area network (VLAN) tagging, Layer 2 forwarding, Layer 3 capabilities, and the like. OVS can support the OpenFlow Protocol, allowing the virtual switch to be controlled by a network controller to make decisions about how traffic should be routed through the network. A network controller, such as a software-defined networking (SDN) controller, is a centralized entity that manages flow control to the networking devices. It is the “brain” of the network, maintaining a comprehensive view of the network and making decisions about where to send packets. The OpenFlow (OF) Protocol enables the controller to interact directly with the forwarding plane of network devices, such as switches and routers, both physical and virtual. An OF configuration refers to the setup and management of network behavior using the OpenFlow protocol within an SDN environment. It involves defining flow rules and actions to control how traffic is handled by network devices, usually managed centrally by an SDN controller. An OF configuration can include flow tables that contain rules for how packets should be handled. Each flow table contains a set of flow entries. The flow entry defines what to do with packets that match certain criteria. An entry can have three parts: match fields, actions, and counters. The match fields define packet attributes to match, such as source/destination Internet Protocol (IP) addresses, Media Access control (MAC) addresses, port numbers, VLAN tags, etc. The Actions can define what to do with a matching packet, such as forwarding it to a specific port, modifying fields in the packet, or dropping it. The counters can be used to keep track of the number of packets and bytes for each flow. The network controller can use control messages to manage flow entries in the switches. It can add, update, or delete flow entries. Optional configurations can include group tables for more advanced forwarding actions like multicasting, load balancing, etc. It should be noted that OVS is a type of virtual switch technology, but there are other virtual switch technologies, such as SDN-based switches.

An OVS bridge acts like a virtual network switch at the software level, allowing multiple network interfaces to be connected and managed as if they were ports on a physical switch. The OVS bridge can enable the creation and management of virtual networks within a server or across multiple servers in a data center or cloud environment. An OVS bridge connects virtual and physical network interfaces, facilitating communication between them. This can include interfaces from VMs, containers, physical network interfaces, or even other virtual bridges. Similar to a physical Ethernet switch, an OVS bridge operates at Layer 2 (L2) of the Open Systems Interconnection model (referred to as the OSI model), forwarding, filtering, and managing traffic based on Media Access Control (MAC) addresses. An OVS bridge can support advanced features such as virtual local area network (VLAN) tagging, Quality of Service (QoS), traffic mirroring, and Access Control Lists (ACLs), among others. An OVS bridge can be controlled by a controller using protocols like OpenFlow (OF), allowing for dynamic and programmable network configurations.

Some aspects and embodiments of the present disclosure are described herein with respect to OVS and include terminology that is specific to OVS and OpenFlow. However, some aspects and embodiments of the present disclosure can be used in other virtual switching and bridging technologies. Similarly, various embodiments are described in the context of a DPU, but can also be used in other virtual switch environments, including virtual bridges, switches, network interface controller (NICs) (also referred to as network interface cards), smart NICs, network interface devices, network switches, network adapters, intelligence processing units (IPUs), or other specialized computing devices designed to offload specific tasks from the CPU of a computer or server.

DPUs are specialized semiconductor devices designed to offload and accelerate networking, security, and storage tasks that traditionally run on server CPUs. By taking over these functions, DPUs aim to significantly improve overall data center efficiency and performance. They are equipped with their own processors and memory, enabling them to handle complex data processing tasks independently of the host CPU. DPUs are embedded into the data center infrastructure, where they manage data movement and processing across networks, freeing up CPU resources to focus more on application and workload processing. This architectural shift allows for increased workload density, improved data throughput, and enhanced security measures at the hardware level. DPUs play a pivotal role in software-defined networking (SDN), providing hardware acceleration for advanced functions such as encryption, traffic management, and virtualization. By optimizing these crucial operations, DPUs contribute to the creation of more agile, secure, and efficient data centers.

IPUs are specialized hardware accelerators designed to optimize the performance of machine learning algorithms and artificial intelligence (AI) workloads. Unlike general-purpose CPUs or Graphics Processing Units (GPUs) which are versatile but may not be optimized for AI tasks, IPUs are engineered specifically to handle the high computational demands and data throughput requirements of deep learning models and neural network processing. They achieve this by implementing highly parallel computation architectures and memory systems that can efficiently process the large volumes of data associated with AI applications. IPUs aim to reduce the latency and increase the speed of AI computations, enabling more complex models to be trained more quickly and efficiently.

Smart NICs are advanced network interface cards equipped with built-in processing power to offload networking tasks from the CPU, thereby enhancing the efficiency and performance of data processing within servers. Unlike traditional NICs, which primarily serve as conduits for data between servers and networks, Smart NICs can execute a wide range of network functions directly on the card, such as traffic management, encryption/decryption, and network virtualization tasks. These capabilities allow Smart NICs to significantly reduce CPU load, freeing up resources to improve the overall processing capabilities of the server for application workloads. By handling complex networking functions, Smart NICs can lead to lower latency and higher throughput in data center environments, making them particularly valuable in scenarios requiring real-time processing and high-speed networking, such as cloud computing, high-performance computing (HPC), and enterprise data centers. The intelligence and programmability of Smart NICs provide a flexible solution to meet the evolving demands of modern networking infrastructures, contributing to more efficient and customizable networking operations.

### Plane Failure and Plane Recovery

Aspects and embodiments of the present disclosure can provide an accelerated routing service that supports plane failure detection (also referred to as link failure) and plane recovery (also referred to herein as “plane failure”). Link failure in network topologies refers to a situation where a communication link between two network devices, such as routers, NICs, switches, or hosts, becomes unavailable due to various reasons such as hardware failure, cable disconnection, or network congestion. Link failures can significantly impact the performance, availability, and reliability of network services, especially in large-scale or critical environments like data centers or enterprise networks. The are several reasons which might cause link failure, such as physical link failures (e.g., damage or disconnection of cables due to fiber cuts, broken Ethernet cables, etc.), device failures (e.g., hardware failures causing interfaces to go down), congestion or overload (i.e., network links overloaded with too much traffic causing timeouts or packet drops), software bugs or misconfigurations that cause a network device to drop connections, power failures, maintenance activities (e.g., planned outages for maintenance or upgrades might also cause temporary link failures), or the like.

There can be different implications for link failures. When a link goes down, packets that were being transmitted over that link are lost. This can result in transmission delays and affect real-time applications (e.g., VOIP, streaming). Connections between devices relying on the failed link will become unavailable until rerouting occurs. With the link down, traffic may need to be routed through alternative, longer paths that introduce higher latency, negatively impacting application performance. If the failed link were part of a redundant configuration (like in ECMP, Spanning Tree Protocol (STP), or dual-homed devices), traffic could be rerouted to an alternate link. However, this can result in a reduced level of redundancy. In networks running dynamic routing protocols (e.g., Open Shortest Path First (OSPF), Border Gateway Protocol (BGP), Intermediate System to Intermediate System (IS-IS)), when a link fails, the network must re-converge by recalculating new routes. This convergence can take time during which the affected parts of the network may be unreachable. Rerouting traffic from a failed link may lead to congestion on alternative paths if the rerouted traffic exceeds the capacity of those paths. Mission-critical applications, like financial services or online gaming, may experience downtime or degraded performance due to a link failure. TCP connections may experience retransmissions, which can increase latency, while UDP connections may suffer from data loss without retries. Point-to-point communication may stop altogether until the network converges or the failed link is restored, potentially causing outages. Services relying on high availability (HA) solutions may be impacted if there is no failover path or the failover mechanism takes too long to activate.

One routing strategy is called ECMP. ECMP is a routing strategy that allows multiple forwarding paths for a packet towards a destination when multiple paths have the same routing cost (or metric). By leveraging ECMP, networks can balance traffic across multiple paths, increase bandwidth utilization, improve redundancy, and provide fault tolerance. Due to the implications for link failure mentioned above, it is important to have fast recovery when link goes down. In particular, when link goes down, an ECMP group must be updated immediately to reflect that a specific link is no longer available. Also, when the link goes up, the ECMP group must be updated immediately with the recovered link to allow better network utilization.

As described below in more detail, the accelerated routing service can periodically monitor links. For example, all ports in a specific ECMP group can be monitored using inter-process communication (IPC) messages, such as Linux Netlink messages from a Linux kernel.

If a link goes down (i.e., experiences a link failure), the accelerated routing service identifies the link as being down and updates an ECMP group immediately by removing the link from the ECMP group. That is, the accelerated routing service updates the ECMP group in the tables to remove the failed link. Once the ECMP group is updated, the traffic can be distributed to other links in the ECMP group.

If a link goes up (i.e., no longer experiences a link failure), the accelerated routing service identifies the link as being up and updates the ECMP group immediately by adding the link from the ECMP group. That is, the accelerated routing service updates the ECMP group in the tables to add the recovered link (also referred to as a new link). Once the ECMP group is updated, the traffic can be distributed to the new link along with the other links in the ECMP group.

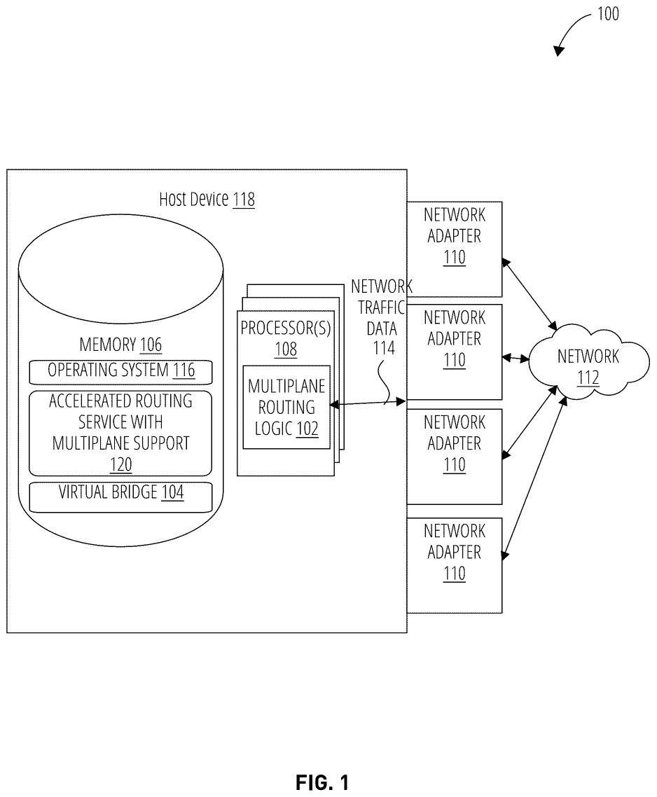

FIG. 1 is a block diagram of a computing system 100 with a multiplane routing logic 102 for providing a virtual bridge 104 and an accelerated routing service with multiplane support 120 according to at least one embodiment. The computing system 100 includes a host device 118 and multiple network adapters 110. The host device 118 can be a server, In this embodiment, four network adapters 110 are illustrated, but other number of network adapters can be used. The network adapter 110 can be network interface controller (NIC), a data processing unit (DPU), a Smart NIC, a network interface device, or the like. Each of the network adapters 110 is coupled to a leaf switch of a network 112. The network 112 can be a public network (e.g., the Internet) or a private network (e.g., a local area network (LAN) or wide area network (WAN)). In at least one embodiment, the computing system 100 is part of a data center, as described herein.

In at least one embodiment, the computing system 100 is located in a data center. The host device 118 refers to a computing device that runs applications, manages workloads, or provides services to clients or other systems. The host device 118 can be a physical server (e.g., rack servers, blade servers, tower servers), a virtual machine (VM) (e.g., hosted on a hypervisor), a bare-metal server, a cloud instance, a high-performance computing (HPC) node, an application server, a container host, a storage host, or the like. The host device 118 can include a memory 106, one or more processors 108. The processors 108 can be one or more central processing units (CPUs), graphics processing units (GPUs), intelligence processing units (IPUs), accelerators (e.g., acceleration hardware engines), etc. The memory 106 can store instructions for an operating system 116, an accelerated routing service with multiplane support 120, and a virtual bridge 104. The processor 108 can include multiplane routing logic 102 that provides an accelerated routing service with multiplane support 120 and virtual bridge 104. The processor 108 can host the virtual bridge 104 and the accelerated routing service with multiplane support 120, as described in more detail below. The virtual bridge 104 (also referred to as a virtual switch) is software that operates within a computer network to connect different segments or devices, much like a physical network bridge, but in a virtualized environment. It is a core component in network virtualization, enabling the connection of virtual machines (VMs), containers, and other virtual network interfaces to each other and to the physical network, simulating traditional Ethernet network functions purely in software. Virtual bridge 104 allow for the creation and management of isolated network segments within a single physical infrastructure, facilitating communication, enforcing security policies, and providing bandwidth management, all while offering the flexibility and scalability needed in dynamic virtualized and cloud environments. The virtual bridge 104 can be Open vSwitch (OVS) bridges. An OVS bridge functions as a virtual switch at the heart of the Open vSwitch architecture, enabling advanced network management and connectivity in virtualized environments. It operates by aggregating multiple network interfaces into a single logical interface, managing the traffic flow between VMs on the same physical host, as well as the external network. Unlike traditional virtual bridges, the OVS bridge supports a wide array of networking features, such as VLAN tagging, traffic monitoring with sFlow and NetFlow, Quality of Service (QoS), and Access Control Lists (ACLs), offering enhanced flexibility and control for network administrators. The OVS bridge efficiently directs network traffic, based on pre-defined policies and rules, providing an essential tool for building complex, multi-tenant cloud and data center networks.

In particular with respect to FIG. 1, the virtual bridge 104 can provide network connectivity between VMs executed on the same computing system 100 or a separate host device, containers, and/or physical devices. In short, the virtual bridge 104 allows VMs on a single physical host to communicate with each other and with the network 112. The virtual bridge 104 can emulate the functionality of a physical network switch but operates at a software level within the computing system 100. The virtual bridge 104 can manage network traffic data 114, directing data packets between VMs on the same host or between VMs and the physical network using ports. These ports can be configured for various policies like security settings, QoS rules, etc. The virtual bridge 104 can segment network traffic to provide isolation between different virtual networks. The virtual bridge 104 can provide an interface between the virtualized environment and the physical network, allowing VMs to communicate outside their host. The virtual bridge 104 can support standard networking protocols and features, such as VLAN tagging, Layer 2 (L2) forwarding, Layer 3 (L3) capabilities, tunneling protocols (e.g., Virtual Extensive LAN (VXLAN), Generic Routing Encapsulation (GRE), and the Geneve protocol), flow-based forwarding, OpenFlow Support, integration with virtualization platforms (e.g., VMware, KVM, Xen, and others, enabling network connectivity for virtual machines and containers), extensibility, traffic monitoring and mirroring, security, multi-platform support (e.g., Linux, FreeBSD, Windows, etc.), and the like. For Layer 2 Switching, one or more of the virtual bridge 104 acts as a Layer 2 Ethernet switch, enabling the forwarding of Ethernet frames between different network interfaces, including virtual and physical ports. For Layer 3 Routing, one or more of the virtual bridge 104 supports Layer 3 IP routing, allowing it to route traffic between different IP subnets and perform IP-based forwarding. The virtual bridge 104 can support VLAN tagging and allow for the segmentation of network traffic into different VLANs using VLAN tagging. The virtual bridge 104 can use flow-based forwarding where network flows are classified based on their characteristics, and packet forwarding decisions are made based on flow rules, as well as enforce security policies and access control. OVS is commonly used in data center and cloud environments to provide network agility, flexibility, and automation. It plays a vital role in creating and managing virtual networks, enabling network administrators to adapt to the changing demands of modern, dynamic data centers.

In at least one embodiment, the virtual bridge 104 can use the OVS and OF technologies. The virtual bridge 104 can be controlled by the accelerated routing service with multiplane support 120. The accelerated routing service with multiplane support 120 can be a network controller (also referred to as a network service) to make decisions about how traffic should be routed through the network 112. As described herein, a network controller (e.g., SDN controller) is a centralized entity that manages flow control to the networking devices. The OF protocol can be used to interact directly with the forwarding plane of network devices, such as virtual or physical switches and routers. In at least one embodiment, the virtual bridge 104 can use flow tables that contain rules for how packets should be handled. Each flow table contains a set of flow entries. The flow entry defines what to do with packets that match certain criteria. An entry can have three parts: match fields, actions, and counters. The match fields define packet attributes to match, such as source/destination Internet Protocol (IP) addresses, Media Access control (MAC) addresses, port numbers, VLAN tags, etc. The actions can define what to do with a matching packet, such as forwarding it to a specific port, modifying fields in the packet, or dropping it. The counters can be used to keep track of the number of packets and bytes for each flow. Since the virtual bridge 104 is virtualized, the virtual bridge 104 can create rules at a software level, a data path (DP) level, and at a hardware level. A rule created at the software level is referred to as a software (SW) rule or an OF rule. A rule created at the DP level is referred to as a DP rule. A rule created at the hardware level is referred to as a hardware (HW) rule. When a SW rule is created, corresponding DP and HW rules are created. A network controller can add, update, or delete flow entries, changing the configuration settings.

In another embodiment, the virtual bridge 104 is a Standard Virtual Switch or a Distributed Virtual Switch. In another embodiment, the virtual bridge 104 is an SDN-based switch that is integrated with an SDN controller. The computing system 100 can be used in data centers, cloud computing environments, development and testing environments, network function virtualization (NFV) environments, or the like. The virtual bridge 104 can be used in a data center where server virtualization is common to facilitate communication within and between servers efficiently. The virtual bridge 104 in the cloud computing environment can enable multi-tenant networking, allowing different clients to have isolated network segments. The virtual bridge 104 can allow network function virtualizations (e.g., NFVs) to be connected and managed within virtual infrastructures. Some advantages of the virtual bridge 104 is that the virtual bridge 104 can be easily configured or reconfigured without physical intervention, can reduce the need for physical network hardware and associated maintenance, offers the ability to create isolated networks for different applications or tenants. In summary, the virtual bridge 104 is a software-based device that performs the networking functionalities of a physical switch in a virtualized environment (e.g., data centers and cloud computing environments) and provides flexibility, isolation, and efficient network management in the virtualized environment.

In at least one embodiment, the computing system 100 can also host one or more hypervisors and one or more virtual machines (VMs). The network traffic data 114 can be directed to the respective VM by the virtual bridge 104.

During operation, the multiplane routing logic 102 can use a configuration file to generate the virtual bridge 104 that can be controlled by the accelerated routing service with multiplane support 120.

In at least one embodiment, the computing system 100 stores an operating system 116 (OS 116) in memory 106. The computing system 100 can execute the OS 116 on one of the one or more processors 108. In at least one embodiment, the multiplane routing logic 102 generates the virtual bridge 104 and the accelerated routing service with multiplane support 120 as part of the installation of the OS 116 on the host device 118. In another embodiment, the multiplane routing logic 102 can generate the virtual bridge 104 and the accelerated routing service with multiplane support 120 as part of runtime of the computing system 100 and without reinstallation of the OS 116 on the computing system 100. In at least one embodiment, the multiplane routing logic 102 can configure, according to the configuration file, one or more routing rules in the virtual bridge to allow accelerated routing services over multiple planes, as described in more detail below.

As illustrated in FIG. 1, the multiplane routing logic 102 is implemented in the processor 108. In other embodiments, the multiplane routing logic 102 can be implemented in the one or more processors 108 of FIG. 1. In other embodiments, the multiplane routing logic 102 can be implemented as software executed by the host device 118. In other embodiments, the multiplane routing logic 102 can be implemented in processors, computing systems, CPUs, DPUs, smart NICs, IPUs, or the like. The underlying hardware can host the virtual bridge 104 and accelerated routing service with multiplane support 120.

In at least one embodiment, the computing system 100 can be deployed in a Data Center (DC) network or a Service Provider (SP) network. A data center (DC) network is the foundational infrastructure that facilitates communication, data exchange, and connectivity between different computational resources, storage systems, and networking devices within a data center. It is designed to support high-speed data transmission, reliable access to distributed resources, and efficient management of data flows across various physical and virtual platforms. At its core, a DC network integrates a multitude of switches, routers, firewalls, and load balancers, orchestrated by advanced networking protocols and software-defined networking (SDN) technologies to ensure optimal performance, scalability, and security. The architecture of a DC network typically includes both the physical backbone, with high-capacity cables and switches ensuring bandwidth and redundancy, and the virtual overlay, which enables flexibility, quick provisioning, and resource optimization through virtual networks. A well-designed DC network supports a range of applications, from enterprise services to cloud computing and big data analytics, by providing the infrastructure to handle the massive amounts of data, complex computations, and application workloads typical of modern data centers. It plays a crucial role in disaster recovery, data replication, and high availability strategies, ensuring that data center services remain resilient against failures and efficient under varying loads. A Service Provider (SP) network refers to the expansive, high-capacity communication infrastructure operated by organizations that offer various telecommunications, internet, cloud computing, and digital services to businesses, residential customers, and other entities. These networks are engineered to provide wide-ranging coverage, connecting numerous geographical locations, including urban centers, remote areas, and international destinations, to facilitate global communication and data exchange. The architecture of an SP network is multi-layered, incorporating a mix of technologies such as fiber optics, wireless transmission, satellite links, and broadband access to achieve widespread connectivity. Central to these networks are high-performance backbone networks, which are responsible for the high-speed transmission of massive volumes of data across long distances. On top of the physical infrastructure, SP networks deploy advanced networking technologies, including MPLS, software-defined networking (SDN), and network function virtualization (NFV), to enhance the efficiency, flexibility, and scalability of service delivery. Service Provider networks are designed to support a vast array of services, from conventional voice and data services to modern cloud-based applications and streaming services, addressing the evolving demands of consumers and businesses alike. They are crucial for the implementation of the internet, mobile communications, enterprise networking solutions, and the emerging Internet of Things (IOT) ecosystem, ensuring connectivity and accessibility to digital resources and services on a global scale.

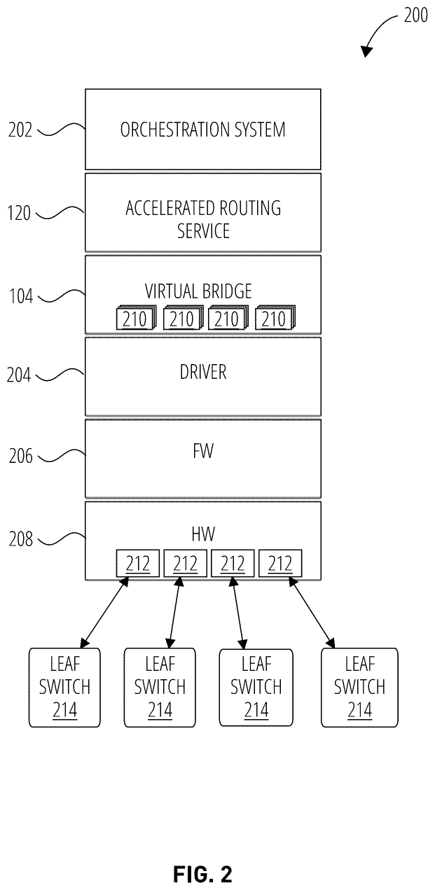

In at least one embodiment, the host device 118 (or computing system 100) can provide the accelerated routing service with multiplane support 120 and the virtual bridge 104 as software layers in a software stack, as illustrated and described below with respect to FIG. 2.

FIG. 2 is a block diagram of a software stack 200 of a host device with a virtual bridge 104 and an accelerated routing service with multiplane support 120 according to at least one embodiment. From the software perspective, the software stack 200 can support the multiple logical ports 210 through a single physical port 212. The software stack 200 can be stored in a memory of the host device 118 of FIG. 1. The software stack 200 includes firmware 206, driver 204, the virtual bridge 104, the accelerated routing service with multiplane support 120, and the orchestration system 202. The firmware 206 can interact with the hardware 208 and the driver 204. The driver 204 can interact with the firmware 206 and the virtual bridge 104. The accelerated routing service with multiplane support 120 can sit on top of the virtual bridge 104. The software stack 200 can be made up of instructions that when executed by the host device can provide the accelerated routing service with multiplane support 120 that supports multiple network protocols and network functions for multiple logical ports (multiple planes). Each logical port 210 correspond to one of multiple planes of a physical port 212.

As illustrated in FIG. 2, the hardware 208 includes one or more physical ports 212 (four physical ports being illustrated) being illustrated for simplicity). Each physical port 212 corresponds to a network adapter 110 (e.g., NIC, DPU, etc.). Each physical port 212 is coupled to a leaf switch 214. The physical port 212 is coupled to a leaf switch 214 of a network. The hardware 208 can include additional hardware, such as a processing device (e.g., one or more CPU cores), one or more GPUs, etc. It should also be noted that the DPU hardware can have more or less physical ports than four physical ports 212. In high-speed networking environments, especially in data centers, it is common to use cables to couple high-speed physical ports 212 (e.g., 40 Gbps or 100 Gbps) to a leaf switch 214. In some cases, a breakout cable can be used. The breakout cable can allow a high-speed port (such as 40 Gbps or 100 Gbps) to be “split” into multiple lower-speed ports (e.g., 4×10 Gbps or 4×25 Gbps). These breakout cables physically separate the data streams and allow multiple devices or ports to connect to a single high-speed interface.

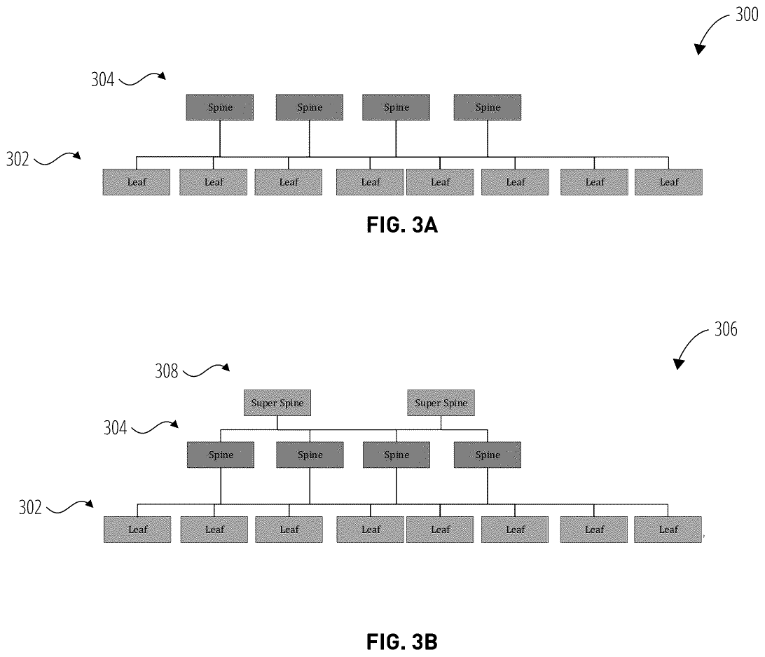

In at least one embodiment, the software stack 200 includes the orchestration system 202. The orchestration system 202 can be used to install, deploy, and configure the accelerated routing service with multiplane support 120. The accelerated routing service with multiplane support 120 can exchange control traffic (e.g., using control protocol such as Border Gateway Protocol (BPG)) with other routing services on other host devices to build a multiplane routing topology. The accelerated routing service with multiplane support 120 can configure, based on the control traffic, the virtual bridge 104 with a first set of multiplane routing rules that specify a first set of available data planes for each of the host devices. The virtual bridge 104 can act as a middleware between the accelerated routing service with multiplane support 120 and lower layer software layers, such as the driver 204 and firmware 206. In at least one embodiment, the virtual bridge 104 can be implemented as an OVS bridge. The driver 204 and firmware 206 can expose registers associated with the network adapters (physical ports 212) for the multiplane decision made by the hardware. The accelerated routing service with multiplane support 120 can configure a set of logical ports 210 for each physical port 212. For example, each physical port 212 can be configured to support four logical ports 210. In other embodiments, each physical port 212 can be configured to support eight or sixteen logical ports 210. Other number of logical ports can be configured for each physical port 212. The accelerated routing service with multiplane support 120 can define the set of multiple routing rules in a routing table, the routing table specifying one of the multiple planes. The planes (also referred to as paths) can be selected by different methods, with the most common one using a hash, which is typically based on source IP address/destination IP addresses, IP protocol, and Layer-4 (L4) source/destination ports. The hash can be an Equal-Cost Multi-Path (ECMP) hash. ECMP is widely used in Leaf-Spine architectures to distribute traffic evenly across spine switches. It ensures high bandwidth and fault tolerance in large-scale data centers. Using the software stack 200, including the accelerated routing service with multiplane support 120, can better use the 2-tier spine-leaf topology to avoid super spine switches used in a 3-tier spine-leaf topology, as described in more detail below. Examples of a 2-tier spine-leaf topology and a 3-tier spine-leaf topology are illustrated and described below with respect to FIG. 3A and FIG. 3B.

In a further embodiment, the accelerated routing service with multiplane support 120 can determine, using the control traffic, a failure of a first data plane of the first set of available data planes to a second destination host device of the plurality of host devices. The accelerated routing service with multiplane support 120 can override, based on the failure, a selection of the first data plane by hardware of the host device with a selection of a second data plane of the remaining available data planes to the second destination host. The accelerated routing service with multiplane support 120 can route, using the virtual bridge, the second packet to the second data plane.

In at least one embodiment, the firmware 206 can be configured to generate multiple logical ports 210 as physical functions (PFs) and map physical lanes of the physical port 212 to the different logical ports 210. In at least one embodiment, the firmware 206 and driver 204 can present multiple logical ports 210 as PFs to the virtual bridge 104 and accelerated routing service with multiplane support 120. The accelerated routing service with multiplane support 120 can be configured to manage each of the PFs as if it were a separate physical port, even though they are supported over the single physical port 212.

The accelerated routing service with multiplane support 120 can configure different policies to the different PFs. In at least one embodiment, a first logical port is configured with a first policy, and a second logical port is configured with a second policy different than the first policy. In at least one embodiment, the different network functions can include L2 bridging, L3 routing, tunnel encapsulation, tunnel decapsulation, hash calculations, ECMP operations, static and dynamic ACLs, CT, etc. Similarly, different network functions can be performed for the other logical ports (other PFs). Once configured, the hardware 208 can process the network traffic data accordingly.

From the software perspective, the software stack 200 can support ECMP for creating/deleting ECMP groups for multiplane routing. The accelerated routing service with multiplane support 120 can create an ECMP group (e.g., group 0, group 1, etc.). Each ECMP group can include a group of identifiers (e.g., txid=0, txid=1, etc.). These group of identifiers can be used in a routing table. The accelerated routing service with multiplane support 120 can monitor a link status of each plane, and modify the ECMP groups accordingly. In at least one embodiment, the accelerated routing service with multiplane support 120 can receive a failure notification from the accelerated routing services on another host device. The failure notification can indicate that one or more of the planes to that host device has failed. The accelerated routing service with multiplane support 120 can remove that plane from the ECMP group so that the network traffic data being sent to the destination host device can be sent on one of the available data planes to the destination host device. Similarly, when the plane has recovered or been restored, the accelerated routing service with multiplane support 120 can update the ECMP group so that the network traffic data can be sent to the destination host device using the restored plane.

In at least one embodiment, the accelerated routing service with multiplane support 120 can include link monitoring logic that monitors a link availability of each of a plurality of links (i.e., planes) to a destination. The plurality of links can be part or specified in an initial group of identifiers in a routing table. That is, the link monitoring logic can monitor if a link is available by monitoring all ports associated with the initial group of link identifiers. The link monitoring logic can detect a link failure of a first link of the plurality of links. The link failure can also be referred to as a plane failure of a first plane of the multiple planes. The link monitoring logic can notify other logic of the accelerated routing service with multiplane support 120 to remove a first link identifier, associated with the first link, from the initial group of link identifiers to obtain a modified group of link identifiers in an ECMP group table. The accelerated routing service with multiplane support 120 can also cause a routing table to be updated to remove the first link identifier. The hardware 208 can process and distribute the network traffic data to only the remaining links (planes) corresponding to the modified group of identifiers.

In at least one embodiment, the virtual bridge 104 is controlled by the accelerated routing service with multiplane support 120 hosted on the host device 118. The accelerated routing service with multiplane support 120 can know about a link (plane) going down using the control protocol (e.g., BGP). The accelerated routing service with multiplane support 120 can update the virtual bridge 104 accordingly.

In at least one embodiment, the virtual bridge 104 can receive a first packet prior to the link failure of the first link, and perform an IP address lookup for the first packet to identify an ECMP group identifier associated with the plurality of links. The virtual bridge 104 can hash the ECMP group identifier to identify any one of the plurality of links. The virtual bridge 104 can receive a second packet after the link failure of the first link, and perform an IP address lookup for the second packet to identify the ECMP group identifier. The virtual bridge 104 can hash the ECMP group identifier to identify any one of the remaining links.

In at least one embodiment, the accelerated routing service with multiplane support 120 can monitor the link availability of each of the plurality of links to the destination, and detect a link recovery of the first link. The link recovery can also be referred to as a “plane recovery” of a first plane. The accelerated routing service with multiplane support 120 can add the first link identifier to the modified group of link identifiers to obtain the initial group of link identifiers in the ECMP group table. The accelerated routing service with multiplane support 120 can cause the routing table to be updated to add the first link identifier. The hardware 208 can process subsequent network traffic data and distribute the subsequent network traffic data to the plurality of links corresponding to the initial group of identifiers. In at least one embodiment, the virtual bridge 104 can receive a first packet prior to the link recovery of the first link, and perform an IP address lookup for the first packet to identify an ECMP group identifier associated with the plurality of links. The virtual bridge 104 can hash the ECMP group identifier to identify any one of the remaining links. The virtual bridge 104 can receive a second packet after the link recovery of the first link, and perform an IP address lookup for the second packet to identify the ECMP group identifier. The virtual bridge 104 can hash the ECMP group identifier to identify any one of the plurality of links.

As described above, the Spine-Leaf topology is a widely used data center network architecture designed to provide high bandwidth, scalability, and redundancy. Using the software stack 200, including the accelerated routing service with multiplane support 120, can better use the 2-tier spine-leaf topology to avoid super spine switches used in a 3-tier spine-leaf topology, as described in more detail below. Examples of a 2-tier spine-leaf topology and a 3-tier spine-leaf topology are illustrated and described below with respect to FIG. 3A and FIG. 3B.

FIG. 3A is a block diagram of a 2-tier spine-leaf topology 300 according to at least one embodiment. The 2-tier spine-leaf topology 300 includes a leaf layer 302 and a spine layer 304. The leaf layer 302 includes Top-of-Rack (ToR) switches connected to host devices (e.g., servers). The spine layer 304 include high-speed switches connecting all leaf switches of the leaf layer 302. The main advantages of the 2-tier spine-leaf topology 300 are low latency, high bandwidth, and ease of scaling horizontally by adding more spines or leaves. The 2-tier spine-leaf topology 300 has low latency because there are only two switch hops between any two host devices (e.g., servers). The 2-tier spine-leaf topology 300 has high bandwidth through ECMP forwarding. However, there are some limitations of the 2-tier spine-leaf topology 300. There is difficulty in scaling when the number of leaf switches exceeds the port capacity of the spine switches, making it less suitable for very large networks with thousands of racks, and the requirement for traffic between servers to always pass through one spine switch.

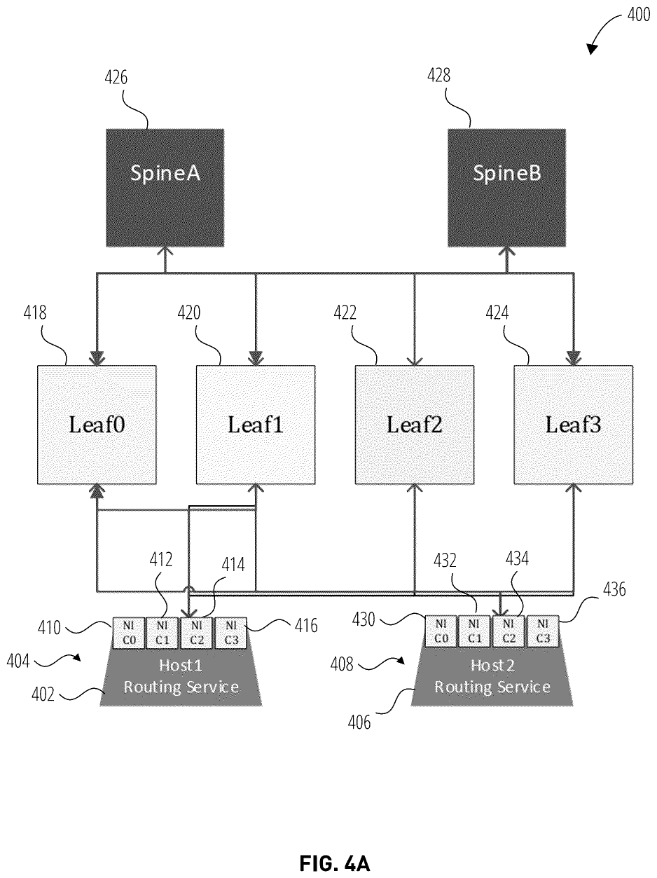

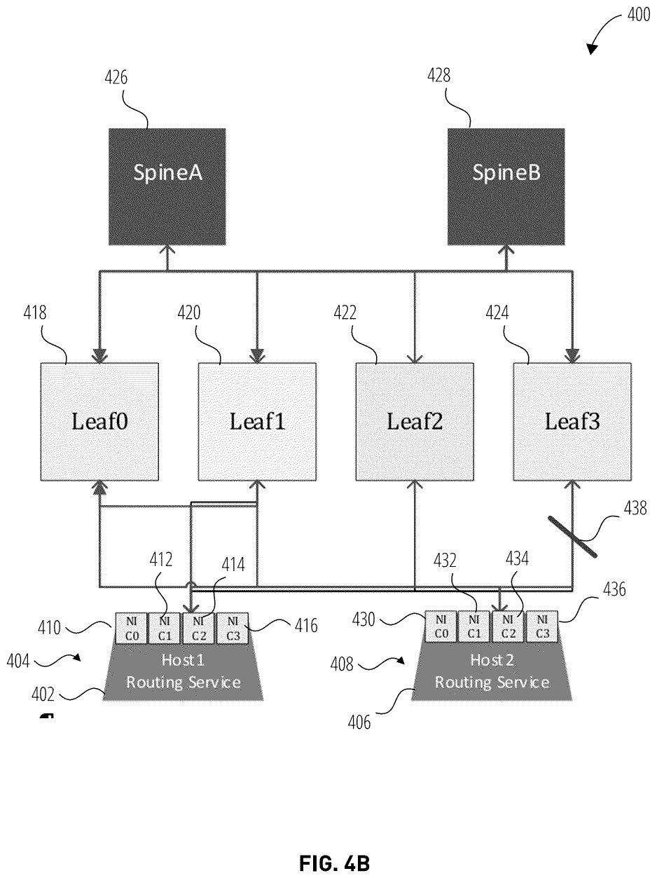

FIG. 3B is a block diagram of a 3-tier spine-leaf topology 306 according to at least one embodiment. The 3-tier spine-leaf topology 306 (also referred to as Super-Spine architecture or topology) includes three layers: the leaf layer 302, the spine layer 304, and a super-spine layer 308 (also referred to as core layer) that connects spine switches of the spine layer 304 in different regions or pods. This architecture scales to thousands of racks by adding super-spines, reducing the port limitation at the spine layer, and enabling a multiplane architecture by separating workloads across multiple fabrics. However, the 3-tier spine-leaf topology 306 can introduce higher latency due to an extra hop, compared to the 2-tier spine-leaf topology 300. The 3-tier spine-leaf topology 306 can involve more complex routing and management, and incurs higher costs due to the additional super-spine layer 308. Using the software stack 200, the number of ports can be increased for each physical port, allowing the scaling in a 2-tier spine-leaf topology 300 as illustrated in FIG. 4A.

FIG. 4A is a block diagram of a multiplane topology 400 where multiple NICs each support multiple planes according to at least one embodiment. The multiplane topology 400 is a 2-tier spine-leaf topology, similar to FIG. 3A, except the multiplane topology 400 supports multiplane routing using an accelerated routing service 402 that supports multiplane. As illustrated in FIG. 4A, a first host device 404 multiplane support by an accelerated routing service 402 with multiplane support. The accelerated routing service 402 can support multiple plane over each of NICs. In the illustrated example, there are four NICs, including a first NIC 410, a second NIC 412, a third NIC 414, and a fourth NIC 416. Each of the four NICs support four planes. In other examples, there can be eight, sixteen or more planes for each of the four NICs. In other embodiments, more or less NICs can be used. It should also be noted that DPUs or other network adapters can be used instead of NICs.

Each packet in the multiplane topology 400 will be sent to one of the four planes (or 8 or 16 planes) supported by the accelerated routing service 402. If all the planes are operational, as illustrated in FIG. 4A, the NIC hardware can divide the network traffic data between the different planes. If one of the remote planes is failed (i.e., not operational), as illustrated in FIG. 4B, the accelerated routing service 402 can identify it using control traffic (e.g., BGP traffic) exchanged with other routing services, such as accelerated routing service 406 of the host device 408. In this example, there is a plane failure 438 of a fourth plane between the fourth leaf switch 424 and the fourth NIC 436. That is, the connection between the fourth leaf switch 424 and the host device 404 is down. The accelerated routing service 406 can send the control traffic, including a failure notification of the fourth plane, to the accelerated routing service 402. The accelerated routing service 406 can notify the accelerated routing service 402 that the fourth plane is down. The accelerated routing service 402 can identify the plane failure 438 using the failure notification. The accelerated routing service 402 can change the multiplane routing rules so that the hardware (e.g., NICs 410 to 416) will not send network traffic data on the remaining three planes. The host devices 404 and 408 can communicate with one another only on the other three planes.

In this embodiment, each host device can communicate with other host devices on each of the four planes per NIC. In other embodiments, each host device can communicate with other host devices on each of the eight or sixteen planes per NIC. In at least one embodiment, the accelerated routing service 402 can provide end-to-end multiplane support, leveraging DPU hardware to perform acceleration, including failure and recovery for cases when links are down. In other embodiments, the accelerated routing service 402 can leverage NIC acceleration to support multiplane routing.

In at least one embodiment, the host device 404 includes a plurality of network adapters (e.g., NICs, DPUs, etc.). The host device 404 can execute instructions of a virtual bridge and the accelerated routing service 402. The accelerated routing service 402 can exchange control traffic with other accelerated routing services executed by a plurality of host devices, such as the accelerated routing service 406 of host device 408. The accelerated routing service 402 can configure, based on the control traffic, the virtual bridge with a first set of multiplane routing rules that specify a first set of available data planes for each of the plurality of host devices. The virtual bridge can configure the underlying hardware of the network adapters (e.g., NICs 410 to 416), such as registers, with the first set of multiplane routing rules. The first set of multiplane routing rules can be a default set of rules that assumes that all planes are up and operational. The virtual bridge can receive a first packet directed to a first destination host device, such as the host device 408, and route the first packet, according to the first set of multiplane routing rules, to one of the first set of available data planes to the first destination host device.

In at least one embodiment, the accelerated routing service 402 can determine, using the control traffic, a plane failure 438 of a first data plane of the first set of available data planes (e.g., plane 4 in FIG. 4B) to the first destination host (e.g., host device 408) or a second destination host device. It should be noted that the first data plane to the host device 408 failed, but the first data plane to other host devices may still be operational. Thus, the accelerated routing service 406 needs to track the status of the planes to each destination accordingly. In at least one embodiment, the accelerated routing service 402 can determine the plane failure 438 of the first data plane by receiving a failure notification, indicating the plane failure 438, from the accelerated routing service 406 of the host device 408. Alternatively, notification of the plane failure 438 can be sent by another accelerated routing service of another host device. The accelerated routing service 402 can modify, based on the plane failure 438, the first set of multiplane routing rules to obtain a second set of multiplane routing rules that specify a second set of multiplane routing rules that specify a second set of available data planes for the first destination host device (or second destination host device). For example, the accelerated routing service 402 can add a higher priority rule to the first set of multiplane routing rules that controls the first packet being sent on one of the available accelerated data planes (and not the failed data plane). That is, the second set of available data planes does not include the first data plane as one of the available data planes. The virtual bridge can configure the underlying hardware of the network adapters (e.g., NICs 410 to 416), such as the registers, with the second set of multiplane routing rules. Thus, when the virtual bridge receives a second packet directed to the first destination host device (or the second destination host device), the virtual bridge routes the second packet, according to the second set of multiplane routing rules, to one of the second set of available data planes to the first destination host device (or second destination host device). For example, the host device 404 routes the second packet over one of the other three available planes and not the fourth plane that has the plane failure 438.

In at least one embodiment, the first packet is received prior to the plane failure 438 of the first data plane and the second packet is received after the plane failure 438 of the first data plane. The virtual bridge can perform an IP address lookup for the first packet to identify an ECMP group identifier associated with the first set of available data planes for the first destination host device. The virtual bridge can hash the ECMP group identifier to identify any one of the first set of available data planes (e.g., first, second, third, and fourth third planes). The virtual bridge can perform an IP address lookup for the second packet to identify the ECMP group identifier, and can hash the ECMP group identifier to identify any one of the second set of available data planes (e.g., first, second, and third planes, and not the fourth plane with the plane failure 438).

In at least one embodiment, the accelerated routing service 402 can determine a recovery of the first data plane to the first destination host device (or a second destination host) using the control traffic. The accelerated routing service 402 can modify, based on the recovery, the second set of multiplane routing rules to obtain the first set of multiplane routing rules that specify the set of available data planes for the first destination host device (or second destination host). The first set of available data planes includes the first data plane. The virtual bridge can configure the underlying hardware of the network adapters (e.g., NICs 410 to 416), such as the registers, with the first set of multiplane routing rules. The virtual bridge can receive a third packet directed to the first destination host device (or the second destination host device), and route the third packet, according to the first set of multiplane routing rules, to one of the first set of available data planes to the first destination host device (or the second destination host device).

In at least one embodiment, the plurality of network adapters is a plurality of NICs, each NIC being coupled to a leaf switch of a plurality of leaf switches. In at least one embodiment, the plurality of network adapters is a plurality of DPUs, each DPU being coupled to a leaf switch of a plurality of leaf switches.

In at least one embodiment, the plurality of network adapters includes at least one of four, eight, or sixteen network adapters. The accelerated routing service 402 can configure, based on the control traffic, each of the plurality of network adapters as supporting at least one of four, eight, or sixteen accelerated data planes, each accelerated data plane corresponding to a logical port, wherein a number of logical ports configured by the accelerated routing service is greater than a number of the plurality of network adapters.

In at least one embodiment, each of the set of available data planes to the first destination host device (e.g., host device 408) provides an independent path to the first destination host device. The virtual bridge can perform an ECMP operation in response to each packet to be routed to the first destination host device.

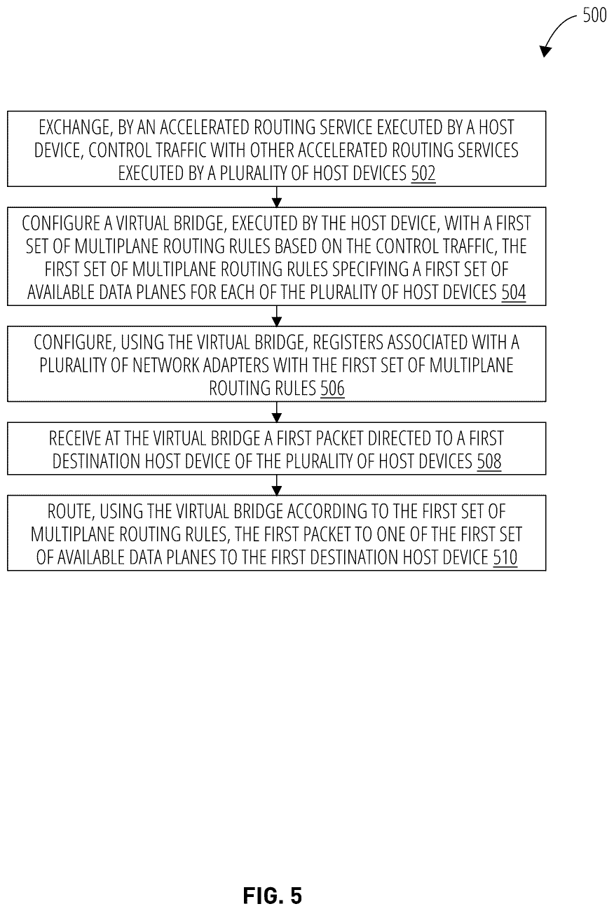

In at least one embodiment, the host device 404 can include one or more processors and memory to store instructions that, when executed by the one or more processors, can provide an accelerated routing service and a virtual bridge to perform operations, such as those described below with respect to method 500 of FIG. 5.

FIG. 5 is a flow diagram of an example method 500 of providing accelerated multiplane routing to destination host devices according to at least one embodiment. The processing logic can be a combination of hardware, firmware, software, or any combination thereof. In at least one embodiment, the processing logic is implemented in a DPU, a switch, a network device, a GPU, a NIC, a CPU, or the like. In at least one embodiment, the processing logic is implemented in an acceleration hardware engine coupled to a switch. In at least one embodiment, method 500 may be performed by multiple processing threads, each thread executing one or more individual functions, routines, subroutines, or operations of the method. In at least one embodiment, processing threads implementing method 500 may be synchronized (e.g., using semaphores, critical sections, and/or other thread synchronization logic). Alternatively, processing threads implementing method 500 may be executed asynchronously with respect to each other. Various operations of method 500 may be performed differently than the order shown in FIG. 5. Some operations of the methods may be performed concurrently with other operations. In at least one embodiment, one or more operations shown in FIG. 5 may not always be performed. In at least one embodiment, the method 500 is performed by computing system 100, multiplane routing logic 102, the processor 108, or accelerated routing service with multiplane support 120 and virtual bridge 104 of FIG. 1. In at least one embodiment, the method 500 is performed by the software stack 200 or the accelerated routing service with multiplane support 120 and virtual bridge 104 of FIG. 2. In at least one embodiment, the method 500 is performed by the host device 404, host device 408, accelerated routing service 402, or accelerated routing service 406 of FIG. 4A and FIG. 4B.

Referring to FIG. 5, the method 500 begins with the processing logic exchanging, by an accelerated routing service executed by a host device, control traffic with other accelerated routing services executed by a plurality of host devices (block 502). At block 504, the processing logic configures a virtual bridge, executed by the host device, with a first set of multiplane routing rules based on the control traffic, the first set of multiplane routing rules specifying a first set of available data planes for each of the plurality of host devices. At block 506, the processing logic configures, using the virtual bridge, registers associated with a plurality of network adapters with the first set of multiplane routing rules. At block 508, the processing logic receives at the virtual bridge a first packet directed to a first destination host device of the plurality of host devices. At block 510, the processing logic routes, using the virtual bridge according to the first set of multiplane routing rules, the first packet to one of the first set of available data planes to the first destination host device.

In a further embodiment, the processing logic determines, using the accelerated routing service and the control traffic, a failure of a first data plane of the first set of available data planes to a second destination host device of the plurality of host devices. The second destination host device can be the first destination host device described above. In at least one embodiment, the processing logic determines the failure by receiving a failure notification from an accelerated routing service of another host device. In at least one embodiment, the processing logic modifies, based on the failure, the first set of multiplane routing rules to obtain a second set of multiplane routing rules that specify a second set of multiplane routing rules that specify a second set of available data planes for the second destination host device. The second set of available data planes does not include the first data plane. The processing logic configures, using the virtual bridge, the registers with the second set of multiplane routing rules. The processing logic receives at the virtual bridge a second packet directed to the second destination host device. The processing logic routes, using the virtual bridge according to the second set of multiplane routing rules, the second packet to one of the second set of available data planes to the second destination host device.

In at least one embodiment, the first packet is received prior to the failure of the first data plane and the second packet is received after the failure of the first data plane. In this embodiment, the processing logic performs an IP address lookup for the first packet to identify an ECMP group identifier associated with the first set of available data planes for the first destination host device. The processing logic hashes the ECMP group identifier to identify any one of the first set of available data planes. The processing logic performs an IP address lookup for the second packet to identify the ECMP group identifier. The processing logic hashes the ECMP group identifier to identify any one of the second set of available data planes.

In a further embodiment, the processing logic determines, using the accelerated routing service and the control traffic, a recovery of the first data plane to the second destination host device. The processing logic modifies, based on the recovery, the second set of multiplane routing rules to obtain the first set of multiplane routing rules that specify the set of available data planes for the second destination host device. The first set of available data planes includes the first data plane. The processing logic configures, using the virtual bridge, the registers with the first set of multiplane routing rules. The processing logic receives at the virtual bridge a third packet directed to the second destination host device. The processing logic routes, using the virtual bridge according to the first set of multiplane routing rules, the third packet to one of the first set of available data planes to the second destination host device.

In at least one embodiment, the third packet is received prior to the recovery of the first data plane and the fourth packet is received after the recovery of the first data plane. In this embodiment, the processing logic performs an IP address lookup for the third packet to identify an ECMP group identifier associated with the second set of available data planes for the first destination host device. The processing logic hashes the ECMP group identifier to identify any one of the first set of available data planes. The processing logic performs an IP address lookup for the second packet to identify the ECMP group identifier. The processing logic hashes the ECMP group identifier to identify any one of the first set of available data planes.

In at least one embodiment, the method further includes determining, using the accelerated routing service and the control traffic, a failure of a first data plane of the first set of available data planes to a second destination host device of the plurality of host devices. The method overrides, based on the failure, a selection of the first data plane by hardware of the host device with a selection of a second data plane of the remaining available data planes to the second destination host. The method routes, using the virtual bridge, the second packet to the second data plane.

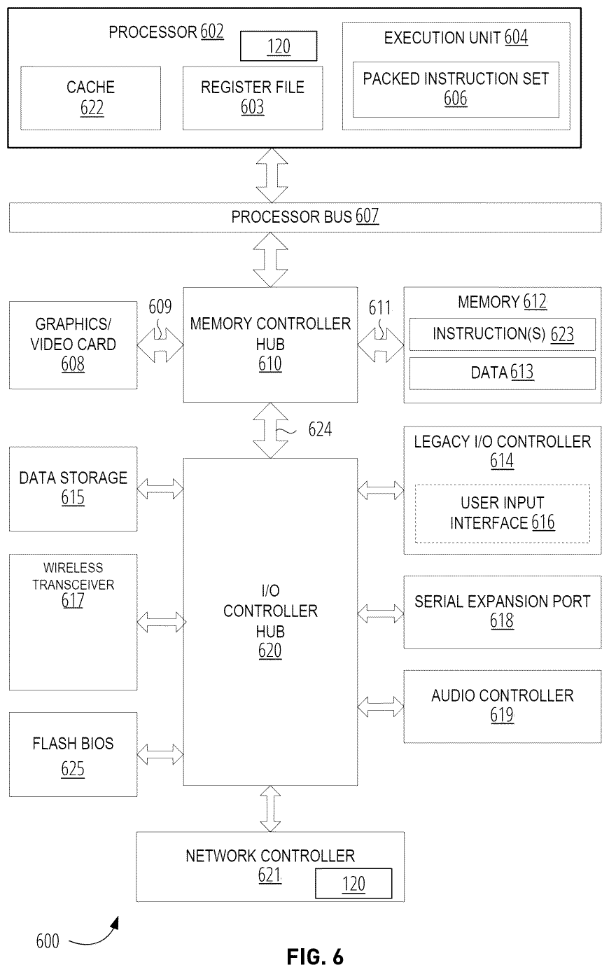

FIG. 6 illustrates an example computer system 600, including an accelerated routing service with multiplane support 120, in accordance with at least some embodiments. In at least one embodiment, the computer system 600 may be a system with interconnected devices and components, an SOC, or some combination. In at least one embodiment, the computer system 600 is formed with a processor 602 that may include execution units to execute an instruction. In at least one embodiment, the computer system 600 may include, without limitation, a component, such as a processor 602, to employ execution units including logic to perform algorithms for processing data. In at least one embodiment, the computer system 600 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer system 600 may execute a version of WINDOWS' operating system available from Microsoft Corporation of Redmond, Wash., although other operating systems (UNIX and Linux, for example), embedded software, and/or graphical user interfaces, may also be used.

In at least one embodiment, the computer system 600 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 600 may be used in devices such as graphics processing units (GPUs), network adapters, central processing units, and network devices such as switches (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 600 may include, without limitation, processor 602 that may include, without limitation, one or more execution units 604 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, the computer system 600 is a single processor desktop or server system. In at least one embodiment, the computer system 600 may be a multiprocessor system. In at least one embodiment, processor 602 may include, without limitation, a CISC microprocessor, a RISC microprocessor, a VLIW microprocessor, and a processor implementing a combination of instruction sets, or any other processor device, such as a digital signal processor, for example. In at least one embodiment, processor 602 may be coupled to a processor bus 607 that may transmit data signals between processor 602 and other components in the computer system 600.

In at least one embodiment, processor 602 may include, without limitation, a Level 1 (“L1”) internal cache memory (“cache”) 622. In at least one embodiment, processor 602 may have a single internal cache or multiple levels of internal cache. In at least one embodiment, cache memory may reside externally to processor 602. In at least one embodiment, processor 602 may also include a combination of both internal and external caches. In at least one embodiment, a register file 603 may store different types of data in various registers including, without limitation, integer registers, floating point registers, status registers, and instruction pointer register.

In at least one embodiment, execution unit 604, including, without limitation, logic to perform integer and floating point operations, also resides in processor 602. Processor 602 may also include a microcode (“ucode”) read only memory (“ROM”) that stores microcode for certain macro instructions. In at least one embodiment, execution unit 604 may include logic to handle a packed instruction set 606. In at least one embodiment, by including packed instruction set 606 in an instruction set of a general-purpose processor 602, along with associated circuitry to execute instructions, operations used by many multimedia applications may be performed using packed data in a general-purpose processor 602. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 605 may also be used in microcontrollers, embedded processors, graphics devices, DSPs, and other types of logic circuits. In at least one embodiment, computer system 600 may include, without limitation, a memory 612. In at least one embodiment, memory 612 may be implemented as a DRAM device, an SRAM device, flash memory device, or other memory devices. Memory 612 may store instruction(s) 623 and/or data 613 represented by data signals that may be executed by processor 602.

In at least one embodiment, a system logic chip may be coupled to a processor bus 607 and memory 612. In at least one embodiment, the system logic chip may include, without limitation, a memory controller hub (“MCH”) 610, and processor 602 may communicate with MCH 610 via processor bus 607. In at least one embodiment, MCH 610 may provide a high bandwidth memory path 611 to memory 612 for instruction and data storage and for storage of graphics commands, data, and textures. In at least one embodiment, MCH 610 may direct data signals between processor 602, memory 612, and other components in computer system 600 and may bridge data signals between processor bus 607, memory 612, and a system I/O 624. In at least one embodiment, a system logic chip may provide a graphics port for coupling to a graphics controller. In at least one embodiment, MCH 610 may be coupled to memory 612 through high bandwidth memory path 611, and graphics/video card 608 may be coupled to MCH 610 through an Accelerated Graphics Port (“AGP”) interconnect 609.

In at least one embodiment, computer system 600 may use system I/O 624 that is a proprietary hub interface bus to couple MCH 610 to I/O controller hub (“ICH”) 620. In at least one embodiment, ICH 620 may provide direct connections to some I/O devices via a local I/O bus. In at least one embodiment, a local I/O bus may include, without limitation, a high-speed I/O bus for connecting peripherals to memory 612, a chipset, and processor 602. Examples may include, without limitation, an audio controller 619, a firmware hub (“flash BIOS”) 726, a wireless transceiver 617, a data storage 615, a legacy I/O controller 614 containing a user input interface 616, a keyboard interface, a serial expansion port 618, such as a USB, and a network controller 621. In at least one embodiment, the network controller 621 includes the accelerated routing service with multiplane support 120. In at least one embodiment, the processor 602 includes the accelerated routing service with multiplane support 120. In at least one embodiment, the instructions instruction(s) 623 perform operations of the accelerated routing service with multiplane support 120. Data storage 615 may comprise a hard disk drive, a floppy disk drive, a CD-ROM device, a flash memory device, or other mass storage device.

In at least one embodiment, FIG. 6 illustrates a system, which includes interconnected hardware devices or “chips.” In at least one embodiment, FIG. 6 may illustrate an example SoC. In at least one embodiment, devices illustrated in FIG. 6 may be interconnected with proprietary interconnects, standardized interconnects (e.g., PCIe), or some combination thereof. In at least one embodiment, one or more components of system 601 are interconnected using compute express link (“CXL”) interconnects.

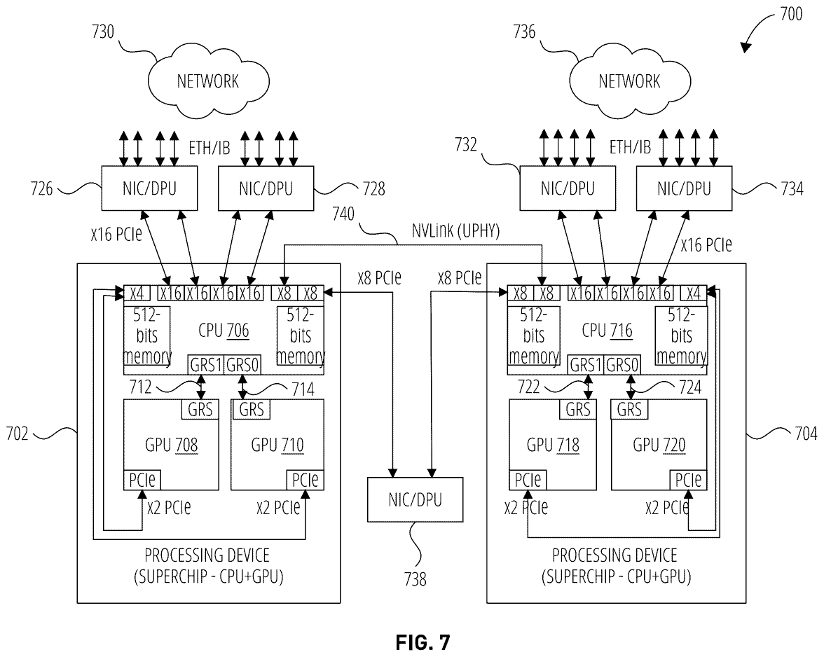

FIG. 7 is a block diagram of a computing system 700 having two processing devices coupled to each other and multiple networks according to at least one embodiment. The computing system 700 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a NIC or Data Processing Unit (DPU) to ensure efficient data transfer across the computing system 700. The coupling of processing devices through NVLink allows for seamless data exchange and parallel processing, enhancing overall computational performance. Additionally, these processing devices are connected to multiple networks through one or more NICs or DPUs, enabling the system to handle complex, multi-network tasks with high bandwidth and low latency. This configuration makes the computing system 700 highly suitable for demanding applications that require significant processing power, such as artificial intelligence (AI), machine learning (ML), and data-intensive computing, while ensuring robust connectivity and scalability across various networked environments. The integrated circuits of the computing system 700 can include one or more CPUs and one or more GPUs. An example architecture of a multi-GPU architecture is illustrated in FIG. 7.

As illustrated in FIG. 7, the computing system 700 includes a processing device 702 with a multi-GPU architecture. In particular, the processing device 702 includes a CPU 706, a GPU 708, and a GPU 710. The CPU 706 can be coupled to the GPU 708 via an die-to-die (D2D) or chip-to-chip (C2C) interconnect 712, such as a Ground-Referenced Signaling interconnect (GRS interconnect). The CPU 706 can be coupled to the GPU 710 via a D2D or C2C interconnect 714. The CPU 706 can also be coupled to the GPU 708 and GPU 710 via PCIe interconnects. The CPU 706 can be coupled to one or more NICs or data processing units (DPUs), which are coupled to one or more networks. For example, as illustrated in FIG. 7, the CPU 706 is coupled to a first NIC/DPU 726, which is coupled to a network 730. The CPU 706 is also coupled to a second NIC/DPU 728, which is coupled to the network 730. The NIC/DPU 726 and NIC/DPU 728 can be coupled to the network 730 over Ethernet (ETH) or InfiniBand (IB) connections.

The computing system 700 also includes a processing device 704 with a multi-GPU architecture. In particular, the processing device 704 includes a CPU 716, a GPU 718, and a GPU 720. The CPU 716 can be coupled to the GPU 718 via an D2D or C2C interconnect 722. The CPU 716 can be coupled to the GPU 720 via a D2D or C2C interconnect 724. The CPU 716 can also be coupled to the GPU 718 and GPU 720 via PCIe interconnects. The CPU 716 can be coupled to one or more NICs or DPUs, which are coupled to one or more networks. For example, as illustrated in FIG. 7, the CPU 716 is coupled to a first NIC/DPU 732, which is coupled to a network 736. The CPU 716 is also coupled to a second NIC/DPU 734, which is coupled to the network 736. The NIC/DPU 732 and NIC/DPU 734 can be coupled to the network 736 over Ethernet (ETH) or InfiniBand (IB) connections.

In at least one embodiment, the processing device 702 and the processing device 704 can communicate with each other via a NIC/DPU 738, such as over PCIe interconnects. The processing device 702 and processing device 704 can also communicate with each other over a high-bandwidth communication interconnects 740, such as an NVLink interconnect or other high-speed interconnects.

The NIC/DPUs of FIG. 7 can be the various embodiments of the DPUs described herein with respect to FIG. 1 to FIG. 6.

In at least one embodiment, the computing system 700 is used for high-speed network communication and includes a processing unit (e.g., CPU 706, GPU 708, GPU 710, CPU 716, GPU 718, GPU 720, NIC/DPU 726, NIC/DPU 728, NIC/DPU 732, NIC/DPU 734, or NIC/DPU 738), and a network interface coupled to the processing unit. The computing system 700 can include the operations and functionality of the accelerated routing service with multiplane support 120 described herein.

In at least one embodiment, the computing system 700 includes a host device and an auxiliary device. The auxiliary device includes a device memory and a processor, communicably coupled to the device memory. The auxiliary device performs the operations described herein with respect to FIG. 1 to FIG. 6. The auxiliary device can include a GPU. The auxiliary device can include a DPU. The auxiliary device can include a DPU. The auxiliary device can include accelerator hardware.

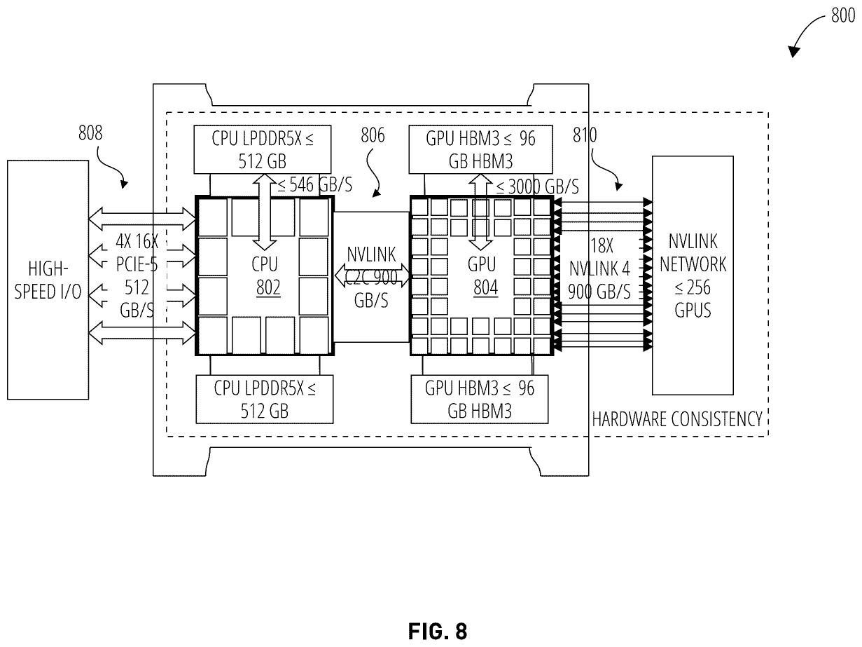

FIG. 8 is a block diagram of a computing system 800 having a CPU 802 and a GPU 804 in a single integrated circuit according to at least one embodiment. The computing system 800 can be a highly integrated design where a CPU 802 and GPU 804 are connected on a single integrated circuit, utilizing an NVLink C2C (Chip-to-Chip) interconnect 806 to enable fast, low-latency communication between the two processing units. This close integration allows for efficient data transfer and parallel processing between the CPU 802 and GPU 804, optimizing performance for complex computational tasks. The GPU elements within the computing system 800 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 810. Additionally, the computing system 800 can be designed to interface with a high-speed I/O through PCIe interconnects 808, ensuring rapid data transfer to and from external devices, further enhancing the system's capabilities in handling data-intensive tasks and providing robust connectivity to peripheral components. It should be noted that the C2C interconnects 806 can be considered D2D interconnects since the CPU 802 and the GPU 804 are located on the same integrated circuit. The integrated circuit can include CPU memory (also referred to as main memory) and GPU memory, which are accessible by the CPU 802 and the GPU 804, respectively, over high-speed interconnects. The computing system 800 can bring together performance of the GPU 804 with the versatility of the CPU 802. The CPU 802 can be connected with a high-bandwidth and memory coherent C2C interconnects 806 in a single integrated circuit. The computing system 800 can support a link switch system.

The computing system 800 can be used for the various embodiments described herein with respect to FIG. 1 to FIG. 7.

In at least one embodiment, the computing system 800 is used for high-speed network communication and includes a processing unit, and a network interface coupled to the processing unit. The computing system 800 can include the operations and functionality of the accelerated routing service with multiplane support 120 described herein.

In at least one embodiment, the computing system 800 includes a host device and an auxiliary device. The auxiliary device includes a device memory and a processor, communicably coupled to the device memory. The auxiliary device performs the operations described herein with respect to FIG. 1 to FIG. 7. The auxiliary device can include a GPU. The auxiliary device can include a DPU. The auxiliary device can include a DPU. The auxiliary device can include accelerator hardware.

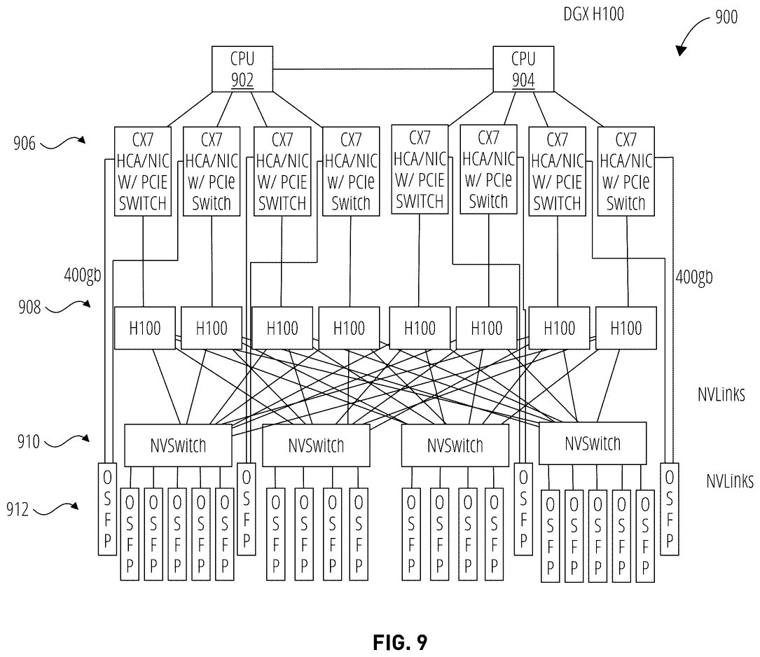

FIG. 9 is a block diagram of a computing system 900 having tensor core GPUs 908 according to at least one embodiment. The computing system 900 can be a DGX H100 system, which is a high-performance computing platform designed to meet the demands of AI, ML, and deep learning (DL) workloads. The computing system 900 can include multiple tensor core GPUs 908 (e.g., NVIDIA H100 Tensor Core GPUs). The tensor core GPUs 908 can each be one of the integrated circuits described above with respect to FIG. 8. The tensor core GPUs 908 can be optimized for AI/ML/DL applications, offering exceptional performance for deep learning training, inference, and high-performance computing tasks. The tensor core GPUs 908 within the computing system 900 are interconnected using high-speed communication interfaces like NVLinks, enabling rapid data transfer between them, which is crucial for handling large-scale AI models and datasets with low latency. This computing system 900 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 908, the computing system 900 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 908 for their specific applications. The computing system 900 is ideally suited for large-scale AI model training, real-time inference, scientific simulations, data analytics, and other compute-intensive tasks that require massive parallel processing power.

The tensor core GPUs 908 can be coupled to multiple CPUs, such as CPU 902 and CPU 904, using switches 906 (e.g., CX7 HCA/NIC with PCIe switch). The tensor core GPUs 908 can be coupled to each other via switches 910 (e.g., NVSwitches). The switches 906 and switches 910 can be coupled to high-speed transceiver modules 912. The high-speed transceiver modules 912 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 900 remains capable of meeting increasing data demands and can be upgraded to support future advancements in network speeds, thus contributing to the system's overall performance and scalability.

In at least one embodiment, the computing system 900 can be considered a data-network configuration with full-bandwidth intra-server NVLinks. In this example, all eight tensor core GPUs 908 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 908 can half-subscribe eighteen NVLinks to GPUs in other servers. Four tensor core GPUs 908 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 908 can independently transfer data, using Remote Direct Memory Access (RDMA) protocol, over its own dedicated switch (e.g., 400 Gb/s HCA/NIC) in an multi-rail InfiniBand/Ethernet configuration. In this example, 800 GBps of aggregate full-duplex to non-NVLink network devices.

The NICs/switches of computing system 900 can include the various embodiments described herein with respect to FIG. 1 to FIG. 8.

In at least one embodiment, the computing system 900 is used for high-speed network communication and includes a processing unit (e.g., CPU 902, CPU 904, switches 906, tensor core GPUs 908, switches 910, high-speed transceiver modules 912), and a network interface coupled to the processing unit. The computing system 900 can include the operations and functionality of the accelerated routing service with multiplane support 120 described herein.

In at least one embodiment, the computing system 900 includes a host device and an auxiliary device. The auxiliary device includes a device memory and a processor, communicably coupled to the device memory. The auxiliary device performs the operations described herein with respect to FIG. 1 to FIG. 17. The auxiliary device can include a GPU. The auxiliary device can include a DPU. The auxiliary device can include a DPU. The auxiliary device can include accelerator hardware.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within range unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., may be either A or B or C, or any nonempty subset of a set of A and B and C. For instance, in the illustrative example of a set having three members, conjunctive phrases “at least one of A, B, and C” and “at least one of A, B, and C” refers to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in at least one embodiment, comprises multiple non-transitory computer-readable storage media, and one or more individual non-transitory storage media of multiple non-transitory computer-readable storage media lack all of the code while multiple non-transitory computer-readable storage media collectively store all of the code. In at least one embodiment, executable instructions are executed such that different instructions are executed by different processors—for example, a non-transitory computer-readable storage medium stores instructions, and a main CPU executes some of the instructions while a GPU executes other instructions. In at least one embodiment, different components of a computer system have separate processors, and different processors execute different subsets of instructions.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that the distributed computer system performs operations described herein and such that a single device does not perform all operations.

Use of any and all examples, or exemplary language (e.g., “such as”) provided herein, is intended merely to better illuminate embodiments of the disclosure, and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

The terms “coupled” and “connected,” along with their derivatives, may be used in the description and claims. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other but yet still CO-operate or interact with each other.

Unless specifically stated otherwise, it may be appreciated that throughout specification terms such as “processing,” “computing,” “calculating,” “determining,” or like, refer to action and/or processes of a computer or computing system or similar electronic computing devices, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, a “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes for carrying out instructions in sequence or parallel, continuously, or intermittently. The terms “system” and “method” are used herein interchangeably as far as a system may embody one or more methods, and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or inter-process communication mechanism.

Although the discussion above sets forth example implementations of described techniques, other architectures may be used to implement the described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A computing system comprising:
a plurality of network adapters; and
a host device comprising a processing device and memory, the memory to store instructions that, when executed by the processing device, is to provide a virtual bridge and an accelerated routing service for routing packets over a plurality of accelerated data planes of each of the plurality of network adapters, wherein:
the accelerated routing service is to exchange control traffic with other accelerated routing services executed by a plurality of host devices;
the accelerated routing service is to configure, based on the control traffic, the virtual bridge with a first set of multiplane routing rules that specify a first set of available data planes for each of the plurality of host devices;
the virtual bridge is to configure registers associated with the plurality of network adapters with the first set of multiplane routing rules; and
the virtual bridge to receive a first packet directed to a first destination host device of the plurality of host devices and route, according to the first set of multiplane routing rules, the first packet to one of the first set of available data planes to the first destination host device.

2. The computing system of claim 1, wherein the accelerated routing service is to:
determine, using the control traffic, a failure of a first data plane of the first set of available data planes to a second destination host device of the plurality of host devices; and
modify, based on the failure, the first set of multiplane routing rules to obtain a second set of multiplane routing rules that specify a second set of multiplane routing rules that specify a second set of available data planes for the second destination host device, wherein the second set of available data planes does not include the first data plane, and wherein the virtual bridge is to:
configure the registers with the second set of multiplane routing rules;
receive a second packet directed to the second destination host device; and
route, according to the second set of multiplane routing rules, the second packet to one of the second set of available data planes to the second destination host device.

3. The computing system of claim 2, wherein the first packet is received prior to the failure of the first data plane and the second packet is received after the failure of the first data plane, wherein the virtual bridge is to:
perform an Internet Protocol (IP) address lookup for the first packet to identify an ECMP group identifier associated with the first set of available data planes for the first destination host device;
hash the ECMP group identifier to identify any one of the first set of available data planes;
perform an IP address lookup for the second packet to identify the ECMP group identifier; and
hash the ECMP group identifier to identify any one of the second set of available data planes.

4. The computing system of claim 2, wherein the accelerated routing service, to determine the failure of the first data plane, is to receive a failure notification, indicating the failure of the first data plane, from one of the other accelerated routing services.

5. The computing system of claim 2, wherein the accelerated routing service is to:
determine, using the control traffic, a recovery of the first data plane to the second destination host device;
modify, based on the recovery, the second set of multiplane routing rules to obtain the first set of multiplane routing rules that specify the set of available data planes for the second destination host device, wherein the first set of available data planes includes the first data plane, and wherein the virtual bridge is to:
configure the registers with the first set of multiplane routing rules;
receive a third packet directed to the second destination host device; and
route, according to the first set of multiplane routing rules, the third packet to one of the first set of available data planes to the second destination host device.

6. The computing system of claim 1, wherein the plurality of network adapters is a plurality of network interface controllers (NICs), each NIC being coupled to a leaf switch of a plurality of leaf switches.

7. The computing system of claim 1, wherein the plurality of network adapters is a plurality of data processing units (DPUs), each NIC being coupled to a leaf switch of a plurality of leaf switches.

8. The computing system of claim 1, wherein the plurality of network adapters comprises at least one of four, eight, or sixteen network adapters, and wherein the accelerated routing service is to configure, based on the control traffic, each of the plurality of network adapters as supporting at least one of four, eight, or sixteen accelerated data planes, each accelerated data plane corresponding to a logical port, wherein a number of logical ports configured by the accelerated routing service is greater than a number of the plurality of network adapters.

9. The computing system of claim 1, wherein the instructions, when executed by the processing device, is further to provide an orchestration system to install, deploy, and configure the accelerated routing service, wherein the virtual bridge is to operate a middleware between the accelerated routing service and a driver and firmware, wherein the driver and firmware are to expose the registers to the virtual bridge.

10. The computing system of claim 1, wherein each of the set of available data planes to the first destination host device provides an independent path to the first destination host device, and wherein the virtual bridge is to perform an Equal-Cost Multi-Path (ECMP) operation in response to each packet to be routed to the first destination host device.

11. A method comprising:
exchanging, by an accelerated routing service executed by a host device, control traffic with other accelerated routing services executed by a plurality of host devices;
configuring a virtual bridge, executed by the host device, with a first set of multiplane routing rules based on the control traffic, the first set of multiplane routing rules specifying a first set of available data planes for each of the plurality of host devices;
configuring, using the virtual bridge, registers associated with a plurality of network adapters with the first set of multiplane routing rules;
receiving at the virtual bridge a first packet directed to a first destination host device of the plurality of host devices; and
routing, using the virtual bridge according to the first set of multiplane routing rules, the first packet to one of the first set of available data planes to the first destination host device.

12. The method of claim 11, further comprising:
determining, using the accelerated routing service and the control traffic, a failure of a first data plane of the first set of available data planes to a second destination host device of the plurality of host devices; and
modifying, based on the failure, the first set of multiplane routing rules to obtain a second set of multiplane routing rules that specify a second set of multiplane routing rules that specify a second set of available data planes for the second destination host device, wherein the second set of available data planes does not include the first data plane;
configuring, using the virtual bridge, the registers with the second set of multiplane routing rules;
receiving at the virtual bridge a second packet directed to the second destination host device; and
routing, using the virtual bridge according to the second set of multiplane routing rules, the second packet to one of the second set of available data planes to the second destination host device.

13. The method of claim 12, wherein the first packet is received prior to the failure of the first data plane and the second packet is received after the failure of the first data plane, and wherein the method further comprising:
performing an Internet Protocol (IP) address lookup for the first packet to identify an ECMP group identifier associated with the first set of available data planes for the first destination host device;
hashing the ECMP group identifier to identify any one of the first set of available data planes;
performing an IP address lookup for the second packet to identify the ECMP group identifier; and
hashing the ECMP group identifier to identify any one of the second set of available data planes.

14. The method of claim 12, wherein determining the failure of the first data plane comprises receiving a failure notification, indicating the failure of the first data plane, from one of the other accelerated routing services.

15. The method of claim 12, further comprising:
determining, using the accelerated routing service and the control traffic, a recovery of the first data plane to the second destination host device;
modifying, based on the recovery, the second set of multiplane routing rules to obtain the first set of multiplane routing rules that specify the set of available data planes for the second destination host device, wherein the first set of available data planes includes the first data plane;
configuring, using the virtual bridge, the registers with the first set of multiplane routing rules;
receiving at the virtual bridge a third packet directed to the second destination host device; and
routing, using the virtual bridge according to the first set of multiplane routing rules, the third packet to one of the first set of available data planes to the second destination host device.

16. A host device comprising:
one or more processors; and
memory to store instructions that, when executed by the one or more processors, is to provide an accelerated routing service and a virtual bridge to perform operations comprising:
exchanging, using the accelerated routing service, control traffic with other accelerated routing services executed by a plurality of host devices;
configuring the virtual bridge with a first set of multiplane routing rules based on the control traffic, the first set of multiplane routing rules specifying a first set of available data planes for each of the plurality of host devices;
configuring, using the virtual bridge, registers associated with a plurality of network adapters with the first set of multiplane routing rules;
receiving at the virtual bridge a first packet directed to a first destination host device of the plurality of host devices; and
routing, using the virtual bridge according to the first set of multiplane routing rules, the first packet to one of the first set of available data planes to the first destination host device.

17. The host device of claim 16, wherein the operations further comprise:
determining, using the accelerated routing service and the control traffic, a failure of a first data plane of the first set of available data planes to a second destination host device of the plurality of host devices; and
modifying, based on the failure, the first set of multiplane routing rules to obtain a second set of multiplane routing rules that specify a second set of multiplane routing rules that specify a second set of available data planes for the second destination host device, wherein the second set of available data planes does not include the first data plane;
configuring, using the virtual bridge, the registers with the second set of multiplane routing rules;
receiving at the virtual bridge a second packet directed to the second destination host device; and
routing, using the virtual bridge according to the second set of multiplane routing rules, the second packet to one of the second set of available data planes to the second destination host device.

18. The host device of claim 17, wherein the first packet is received prior to the failure of the first data plane and the second packet is received after the failure of the first data plane, and wherein the operations further comprise:
performing an Internet Protocol (IP) address lookup for the first packet to identify an ECMP group identifier associated with the first set of available data planes for the second destination host device;
hashing the ECMP group identifier to identify any one of the first set of available data planes;
performing an IP address lookup for the second packet to identify the ECMP group identifier; and
hashing the ECMP group identifier to identify any one of the second set of available data planes.

19. The host device of claim 17, wherein determining the failure of the first data plane comprises receiving a failure notification, indicating the failure of the first data plane, from one of the other accelerated routing services.

20. The host device of claim 17, wherein the operations further comprise:
determining, using the accelerated routing service and the control traffic, a recovery of the first data plane to the second destination host device;
modifying, based on the recovery, the second set of multiplane routing rules to obtain the first set of multiplane routing rules that specify the set of available data planes for the second destination host device, wherein the first set of available data planes includes the first data plane;
configuring, using the virtual bridge, the registers with the first set of multiplane routing rules;
receiving at the virtual bridge a third packet directed to the second destination host device; and
routing, using the virtual bridge according to the first set of multiplane routing rules, the third packet to one of the first set of available data planes to the second destination host device.

21. The host device of claim 16, wherein the operations further comprise:
determining, using the accelerated routing service and the control traffic, a failure of a first data plane of the first set of available data planes to a second destination host device of the plurality of host devices; and
overriding, based on the failure, a selection of the first data plane by hardware of the host device with a selection of a second data plane of the remaining available data planes to the second destination host; and
routing, using the virtual bridge, the second packet to the second data plane.
